(19) United States
(12) Patent Application Publication
(10) Pub. No.: US 2006/0021503 A1
(43) Pub. Date: Feb. 2, 2006

(54) Electrostatic precipitator particulate trap with impingement filtering element

(75) Inventor: David Michael Thaler, Mossville, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar, Inc.

(21) Appl. No.: 10/902,418

(22) Filed: Jul. 30, 2004

(51) Int. Cl. B03C 3/155

(52) U.S. Cl. 95/70; 95/78; 96/56; 96/62; 96/74; 96/97

(57) ABSTRACT

A particulate trap has a housing with an inlet and an outlet. The particulate trap also has an electrostatic filtering device disposed within the housing, a filtering element disposed downstream of the electrostatic filtering device, and an unfiltered flow passageway from the electrostatic filtering device around the filtering element.

### TECHNICAL FIELD

The present disclosure relates generally to an electrostatic precipitator particulate trap and, more particularly, to an electrostatic precipitator particulate trap with an impingement filtering element.

### BACKGROUND

Internal combustion engines, including diesel engines, gasoline engines, natural gas engines, and other engines known in the art, may exhaust a complex mixture of air pollutants. The air pollutants may be composed of gaseous compounds and solid particulate matter, which may include unburned carbon particulates called soot. Due to increased attention on the environment, exhaust emission standards have become more stringent and the amount of particulates emitted from an engine may be regulated depending on the type of engine, size of engine, and/or class of engine. One method that has been implemented by engine manufacturers to comply with the regulation of particulate matter exhausted to the environment has been to remove the particulate matter from the exhaust flow of an engine using an electrostatic precipitator particulate trap.

An electrostatic precipitator generally includes high voltage electrodes (discharge electrodes), which impart a negative charge to particulates entrained within an exhaust gas as the exhaust gas passes near the electrodes.

These negatively charged particulates may then be attracted to a positively charged collecting surface within a particulate trap. However, larger particulates may have an inertial element great enough to dominate over the electrostatic attraction between the charged particulates and the collection surface causing the electrostatic attraction to have little effect on the trajectory of the larger particulates. If the angle of migration towards the collection surface is too shallow, the particulates may not land on the collection surface and will, instead, be swept out of the particulate trap by the flow of exhaust gases.

One method of collecting these larger particulates is described in U.S. Pat. No. 6,185,934 (the '934 patent) issued to Teboul on Feb. 13, 2001. The '934 patent describes a device for filtering engine exhaust gases that includes a first full-flow filter for coarse solid particulates, an electrostatic filtering means mounted downstream of the first full-flow filter, and a second full-flow filter mounted downstream of the electrostatic filtering means. Large particulates are trapped within the first full-flow filter, while smaller particulates pass through the first full-flow filter and are drawn to collection surfaces within the electrostatic filtering means. As the electrostatic filtering means becomes saturated, or when an accumulation of solid particulates detaches from the collection surfaces, the detached accumulations are swept downstream and trapped in the second full-flow filter.

Although the device of the '934 patent may reduce the number of large and small particulates exhausted to the environment, the device may be complex and costly. For example, the device requires multiple filters, which increase the cost as well as the maintenance of the device. In addition, because all of the exhaust flow must pass through both the first and second full-flow filters of the '934 patent, the back pressure within the exhaust system may result in reduced engine performance.

The disclosed particulate trap is directed to overcoming one or more of the problems set forth above.

### SUMMARY OF THE INVENTION

In one aspect, the present disclosure is directed to a particulate trap. The particulate trap includes a housing having an inlet and an outlet. The particulate trap also includes an electrostatic filtering device disposed within the housing, a filtering element disposed downstream of the electrostatic filtering device, and an unfiltered flow passageway from the electrostatic filtering device around the filtering element.

In another aspect, the present disclosure is directed to a method of removing particulates from an exhaust flow. The method includes directing the exhaust flow past at least one electrode to charge particulates entrained within the exhaust flow. The method further includes attracting the charged particulates with at least one collecting surface. The method further includes directing the exhaust flow towards a filtering element and providing an unfiltered flow passageway around the filtering element.

### BRIEF DESCRIPTION OF THE DRAWINGS

FIG. 1 is a diagrammatic illustration of an engine having a particulate trap according to an exemplary disclosed embodiment; and

FIG. 2 is a side view diagrammatic illustration of the particulate trap of FIG. 1.

### DETAILED DESCRIPTION

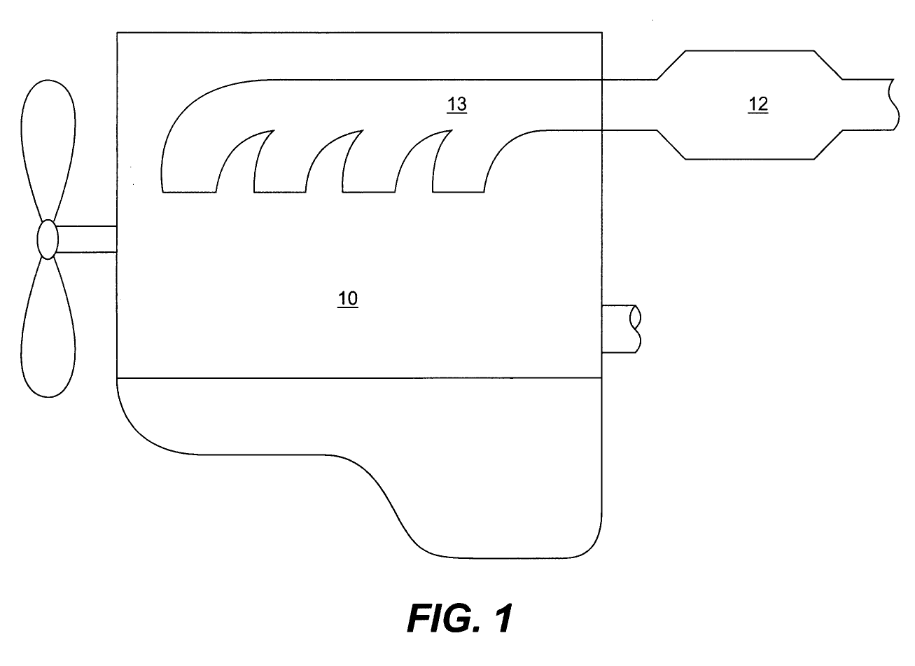

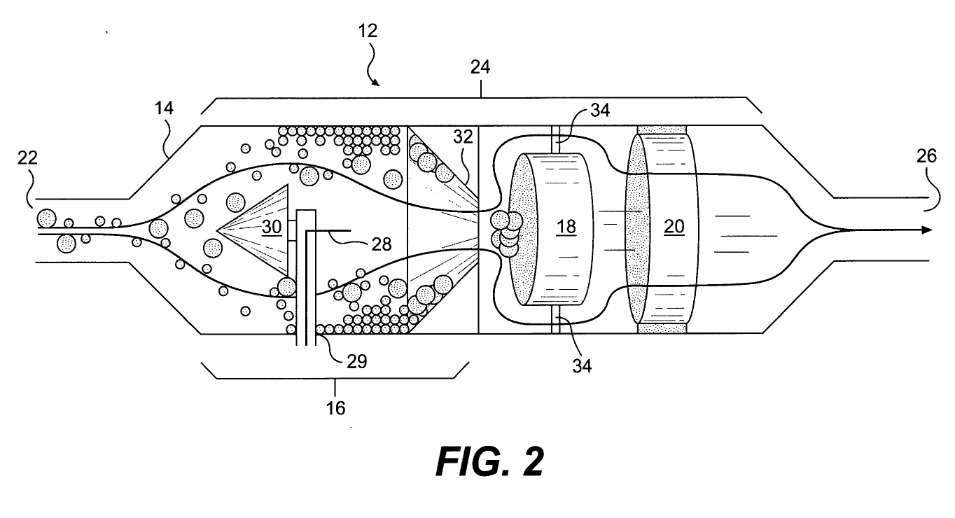

FIG. 1 illustrates an engine 10 having an exemplary particulate trap 12. Engine 10 may include an exhaust manifold 13 connecting an exhaust flow of engine 10 with particulate trap 12. As illustrated in FIG. 2, particulate trap 12 may include a housing 14, an electrostatic filtering device 16, a filtering element 18, and an oxidation catalyst 20.

Housing 14 may have an inlet 22 connected to exhaust manifold 13, a main chamber 24, and an outlet 26. Housing 14 may have a substantially circular cross-section along a length direction. It is also contemplated that housing 14 may have a cross-sectional shape other than circular such as, for example, oval-shaped, square, rectangular, or another appropriate shape.

Housing 14 may be fabricated from an electrically conductive material such as, for example, stainless steel. At least a portion of inlet 22 and outlet 26 may have a substantially circular cross-section. It is also contemplated that inlet 22 and outlet 26 may have a differently shaped cross-section such as square, rectangular, triangular, or other suitable shape. Inlet 22 and outlet 26 may be generally aligned with the length direction of housing 14 and may be disposed on opposite sides of main chamber 24. Inlet 22 may protrude from a first end of particulate trap 12 in the length direction of housing 14. Outlet 26 may protrude from a second end of particulate trap 12, opposite the first end. It is contemplated that one or both of inlet 22 and outlet 26 may not be aligned with the length direction of housing 14 and may protrude from housing 14, for example, orthogonal from the length direction of housing 14. Housing 14 may be electrically grounded.

Electrostatic filtering device 16 may be disposed within main chamber 24 and configured to remove particulates from the exhaust flow. Electrostatic filtering device 16 may include an electrode 28, an insulating means 29, a diverter 30, and a funnel member 32.

Electrode 28 may protrude inward from housing 14 and may be connected to a high-voltage source (not shown) configured to apply a voltage to electrode 28. The voltage applied to electrode 28 may range from 5,000 volts to 30,000 volts or higher, with a preferred range of 7,500 volts to 20,000 volts. As the voltage is applied to electrode 28, a charge may be imparted to the particulates flowing past electrode 28. These charged particulates can migrate towards one or more collecting surfaces such as, for example walls of electrically grounded housing 14. It is contemplated that more than one electrode 28 may be included within electrostatic filtering device 16.

Electrode 28 may be electrically insulated from housing 14 via insulating means 29. Insulating means 29 may be any means for electrically insulating electrode 28 from housing 14 such as, for example, a sleeve positioned between electrode 28 and housing 14 made from an electrically non-conductive material such as, for example, a ceramic, a high-temperature plastic, a fibrous composite, or any other means known in the art. Insulating means 29 may be supported directly by housing 14.

Diverter 30 may be disposed within electrostatic filtering device 16 upstream from electrode 28. Diverter 30 may be connected to insulating means 29 or, alternately, may be connected directly to housing 14. Diverter 30 may be configured to divert the exhaust flow around electrode 28, thereby minimizing or preventing particulate matter build up on electrode 28. Diverter 30 may have a generally conical shape, with the apex distally upstream from electrode 28. It is also contemplated that diverter 30 may have a shape other than conical such as, for example, wedge-shaped, spherical, pyramidal, or another appropriate shape. It is also contemplated that diverter 30 may be omitted from the particulate trap, if desired.

Funnel member 32 may be disposed within electrostatic filtering device 16 downstream from electrode 28 and connected to housing 14. Funnel member 32 may be configured to direct and concentrate the flow of exhaust gasses towards a central flow path of main chamber 24. Funnel member 32 may include a conical surface extending from an outer periphery portion that is sealed to housing 14 to a central through hole located downstream from the outer periphery portion. The central through hole may have a diameter less than the diameter of the outer periphery portion. The central through hole may be aligned with diverter 30 and may have a diameter less than a diameter of diverter 30. In this manner, the amount of flow diverted by diverter 30 flowing directly through electrostatic filtering device 16 without contacting funnel member 32 may be minimized or eliminated. It is contemplated that the through hole may alternately have a diameter equal to or greater than diverter 30. Similar to housing 14, funnel member 32 may be electrically grounded to attract particulates charged by electrode 28.

Filtering element 18 may be disposed within main chamber 24 downstream of electrostatic filtering device 16 and connected to housing 14 via support members 34. Filtering element 18 may be aligned with an outlet of funnel member 32 and may include an impingement-type filtering element having several layers of fine mesh. The size of the mesh openings may vary and may be selected depending on a particular application. Filtering element 18 may be fabricated from an electrically conductive material such as, for example, metallic fibers, carbon fibers, or another electrically conductive material known in the art. Alternately, filtering elements 18 may be fabricated from an electrically non-conductive material such as, for example, a porous ceramic material.

Filtering element 18 may include a means for regeneration. In particular, as particulate matter is deposited on filtering element 18 a soot cake may form. If left unchecked, the soot cake buildup could partially or even fully restrict the flow of exhaust around filtering element 18, allowing for pressure within the exhaust system of engine 10 (referring to FIG. 1) to increase. Regeneration may include heating the soot cake above a combustion temperature of the particulate matter. The regeneration means may include an electrical circuit (not shown) connected to an electrically conductive filtering element 18 for resistive heating, a burner having a flame directed towards filtering element 18, a control system changing an operating condition of engine 10 to increase an exhaust temperature of the exhaust flowing through particulate trap 12, or any other means known in the art. It is further contemplated that filtering element 18 may also be selectively electrically grounded to attract particulates charged by electrode 28.

Oxidation catalyst 20 may be disposed within main chamber 24, downstream of filtering element 18 and configured to oxidize particulate matter that remains in the exhaust flow after passing through electrostatic filtering device 16 and filtering element 18. In particular, oxidation catalyst 20 may include one or more substrates coated with a catalyst material such as, for example, a precious metal-containing washcoat. The precious metal-containing washcoat may aid the reaction of particulate matter with the remaining oxygen in the exhaust gas. It is also contemplated that oxidation catalyst 20 may be omitted from the particulate trap, if desired.

### INDUSTRIAL APPLICABILITY

The disclosed particulate trap may be applicable to any combustion-type device such as, for example, an engine, a furnace, or any other device known in the art where the removal of particulate matter from an exhaust flow is desired. Particulate trap 12 may be a simple, inexpensive, and compact solution for reducing the amount of large and small particulate matter exhausted to the environment without adversely affecting back pressure within the exhaust system. The operation of particulate trap 12 will now be explained.

As exhaust from engine 10 enters particulate trap 12 via inlet 22, voltage may be applied to electrode 28 causing electrode 28 to create an ionizing field. This ionizing field may charge particulate matter that is entrained within the exhaust flow as the particulate matter enters the ionizing field. In order to prevent the particulate matter from adhering to electrode 28 and causing fouling, the exhaust flow may be diverted around electrode 28 by diverter 30.

Simultaneous to charging the particulate matter flowing past electrode 28, the collecting surfaces of housing 14 and funnel member 32 may be electrically grounded, thereby creating an electrostatic attraction between the charged particulate matter and the grounded surfaces of housing 14 and funnel member 32. As the particulate matter flows through electrostatic filtering device 16, this electrostatic attraction may cause the charged particulate matter to migrate toward and adhere to housing 14 and funnel member 32. Smaller particles within the exhaust flow having a lower inertial element may migrate toward housing 14 at a steeper angle than larger particles having a higher inertial element. As a result, larger particles may be deposited generally downstream of the smaller particles, and may be deposited on funnel member 32 instead of housing 14.

As the particulate matter is deposited on housing 14 and funnel member 32, the particulate matter may agglomerate into a soot cake of appreciable mass until the mass reaches a point where its natural adhesion becomes unstable and it flakes off. The flakes may then be swept downstream though funnel member 32 to impinge on filtering element 18. In this manner, large particulates that historically passed through an electrostatic precipitator with deviation from their inertial trajectory, now are caught by filtering element 18 because of their inertial trajectory. Once impinged on filtering element 18, the flakes of agglomerated particulate matter may be stored until a regeneration event.

Although the exhaust flow is directed towards filtering element 18, the majority of the exhaust flow may be redirected around filtering element 18 because of the flow resistance through filtering element 18 and the reduced restriction around filtering element 18. The flakes of agglomerated particulate matter may separate from the main airflow and impinge on filtering element 18 because of their inertial trajectory. It is also contemplated that filtering element 18 may be grounded and thereby attract the charged flakes of agglomerated particulate matter.

After the exhaust flows around filtering element 18, it may be directed through oxidation catalyst 20. Oxidation catalyst 20 may oxidize at least some of the remaining particulate matter within the exhaust flow prior to the exhaust flow exiting particulate trap 12 via outlet 26.

It will be apparent to those skilled in the art that various modifications and variations can be made to the disclosed particulate trap. Other embodiments will be apparent to those skilled in the art from consideration of the specification and practice of the disclosed particulate trap. For example, additional collection surfaces may be included within electrostatic filtering device 16 for the collection of particulates charged by electrode 28. It is intended that the specification and examples be considered as exemplary only, with a true scope being indicated by the following claims and their equivalents.

What is claimed is:

1. A particulate trap, comprising:
a housing having an inlet and an outlet;
an electrostatic filtering device disposed within the housing;
a filtering element disposed downstream of the electrostatic filtering device; and
an unfiltered flow passageway from the electrostatic filtering device around the filtering element.p

2. The particulate trap of claim 1, wherein the electrostatic filtering device includes:
at least one electrode configured to charge particulates passing though the electrostatic filtering device;
at least one collecting surface configured to attract the charged particulates; and
a funnel member disposed downstream of the electrode.

3. The particulate trap of claim 2, further including a diverter disposed upstream of the electrode and configured to divert exhaust flow away from the electrode.

4. The particulate trap of claim 2, wherein the at least one electrode is electrically insulated from the housing.

5. The particulate trap of claim 2, wherein the filtering element is co-axially aligned with an outlet of the funnel member.

6. The particulate trap of claim 1, further including an oxidation catalyst disposed downstream of the filtering element.

7. The particulate trap of claim 1, wherein the filtering element includes an impingement-type filter.

8. The particulate trap of claim 1, further including a direct flow path from an outlet of the funnel member to the filtering element, wherein the unfiltered flow passageway provides for exhaust flow approximately 90 degrees away from the direct flow path.

9. The particulate trap of claim 1, further including a means for regenerating the filtering element.

10. A method of removing particulates from an exhaust flow, comprising:
directing the exhaust flow past at least one electrode to charge particulates entrained within the exhaust flow;
attracting the charged particulates with at least one collecting surface;
directing the exhaust flow towards a filtering element; and
providing an unfiltered flow passageway around the filtering element.

11. The method of claim 10, wherein directing the exhaust flow is accomplished with a funnel member disposed downstream of the at least one electrode.

12. The method of claim 10, further including diverting the exhaust flow around the at least one electrode.

13. The method of claim 12, wherein the diverting is accomplished with a diverting member disposed upstream of the at least one electrode.

14. The method of claim 10, further including regenerating the filtering element.

15. The method of claim 10, further including directing the exhaust flow through an oxidation catalyst filter.

16. A power system, comprising:
a power source operable to produce a flow of exhaust; and
a particulate trap configured to receive the flow of exhaust, the particulate trap including:
a housing having an inlet and an outlet;
an electrostatic filtering device disposed within the housing;
a filtering element disposed downstream of the electrostatic filtering device; and
an unfiltered flow passageway from the electrostatic filtering device around the filtering element.

17. The power system of claim 16, wherein the electrostatic filtering device includes:
at least one electrode configured to charge particulates passing through the electrostatic filtering device;
at least one collecting surface configured to attract the charged particulates; and
a funnel member disposed downstream of the electrode.

18. The power system of claim 16, further including an oxidation catalyst disposed downstream of the filtering element.

19. The power system of claim 16, wherein the filtering element includes an impingement-type filter.

20. The power system of claim 16, further including a direct flow path from an outlet of the funnel member to the filtering element, wherein the unfiltered flow passageway provides for an exhaust flow approximately 90 degrees away from the direct flow path.

21. The power system of claim 16, further including a means for regenerating the filtering element.
